(19) United States
(12) Patent Application Publication
(10) Pub. No.: US 2015/0113664 A1
(43) Pub. Date: Apr. 23, 2015

(54) Preventing Unintentionally Violating Privacy When Sharing and/or Publishing Content

(71) Applicant: Nokia Corporation, Espoo (FI)

(72) Inventors: Imad Aad, Bottens (CH); Nadarajah Asokan, Espoo (FI)

(21) Appl. No.: 14/366,414

(22) PCT Filed: Dec. 27, 2011
(86) PCT No.: PCT/IB2011/055964

§ 371 Date: Jul. 16, 2014

(51) Int. Cl. G06F 21/62

(52) U.S. Cl. CPC G06F 21/6245
USPC 726/27

(57) ABSTRACT

Embodiments of this invention relate to the field of sharing and publishing content. It is inter-alia disclosed to obtain content at a device, to determine whether or not the content is associated with at least one potentially sensitive entity and, in case that it is determined that the content is associated with at least one potentially sensitive entity, non-modally notifying a user of the device that the content is associated with at least one potentially sensitive entity and/or preventing an at least unintentional sharing and/or publishing of the content by a user of the device.

### FIELD

Embodiments of this invention relate to the field of sharing and publishing content.

### BACKGROUND

Recently, there has been a significant interest in providing user-friendly techniques for sharing and/or publishing content such as still or moving images on public platforms. For instance, recently developed computer programs running on mobile devices simplify sharing and/or publishing content captured by mobile devices by causing the mobile devices to automatically or semi-automatically provide content to public platforms such as content-sharing platforms and/or social network platforms. However, sharing and/or publishing content on public platforms may give raise to privacy and liability issues.

For instance, a user of a mobile device may capture an image in a public space and may intend to share the picture with his friends and family on a social network platform. However, if the image happens to unintentionally represent a third person disagreeing with sharing and/or publishing the picture, uploading the image from the mobile device to the social network platform violates privacy of the third person and leaves the user liable for any consequent harm caused to the third person. This is particularly true in cases where the uploaded image is not only available to friends and family of the user, but also to further members of the social network platform.

Therein, it may be irrelevant whether the content violating privacy of a third person was unintentionally or intentionally shared and/or published. Thus, if a computer program runs on a mobile device which for instance causes the mobile device to automatically provide content to a public platform, a user of the mobile device capturing an image unintentionally representing a third person disagreeing with sharing and/or publishing the picture may automatically violate privacy of the third person.

### SUMMARY OF SOME EMBODIMENTS OF THE INVENTION

It is thus inter-alia an object of the invention to provide an apparatus, a method and a computer program preventing unintentionally violating privacy of entities such as third persons when sharing and/or publishing content.

A method according to a first embodiment of the invention comprises obtaining content at a device, determining whether or not the content is associated with at least one potentially sensitive entity and, in case that it is determined that the content is associated with at least one potentially sensitive entity, non-modally notifying a user of the device that the content is associated with at least one potentially sensitive entity and/or preventing an at least unintentional sharing and/or publishing of the content by a user of the device. The non-modal notifying a user of the device that the content is associated with at least one potentially sensitive entity and/or the preventing an at least unintentional sharing and/or publishing of the content by a user of the device, may preferably only be performed in case that it is determined that the content is associated with at least one potentially sensitive entity.

The device may preferably be a mobile device, a communication device and/or a user device. For instance, the device comprises at least one of a user interface, an antenna and a communication interface. Non-limiting examples of the device are a mobile phone such as a so-called smartphone, a digital camera and a mobile computer such as a laptop computer or a so-called tablet computer.

The content may for instance comprise visual content and/or audio content. Non-limiting examples of content are a still image (e.g. a picture, a photo), moving images (e.g. a video, a video recoding), an audio recording (e.g. a recoding of a conversation, an audio track of a video recording), a Bluetooth identifier or a network identifier (e.g. a Medium Access Control (MAC) address and/or an Internet Protocol (IP) address) linkable to the sensitive entity, and combinations thereof. The content may be contained in a data container according to a standard data format such as a Joint Photographic Experts Group (JPEG) format and a Moving Picture Experts Group (MPEG) format, to name but a few non-limiting examples.

The content may be captured by the device, for instance by an integrated content capturing component. Also, the content may be obtained from a content capturing device, for instance received at a communication interface of the device. The content capturing component and/or the content capturing device may comprise an optical and/or acoustical sensor. An optical sensor may for instance be an active pixel sensor (APS) and/or a charge-coupled device (CCD) sensor. The content capturing component and/or the content capturing device may for instance comprise a camera and/or a microphone.

Non-limiting examples of the entity are a (natural) person and a (representational) object (e.g. buildings, bridges, vehicles, consumer products, etc.). An entity may preferably be understood to be associated with the content, if the content represents a characteristic trait of the entity (e.g. the face/voice of a person or an identification of an object such as a license plate of a vehicle). Moreover, an entity may also be understood to be associated with the content, if the content at least potentially represents a characteristic trait of the entity. This may for instance be the case if the entity was at least in proximity at the time when the content was captured (but perhaps is not represented by the content).

The user of the device may for instance be the current user of the device and/or the owner of the device. The user may for instance initiate the sharing and/or publishing of the content.

An entity may for instance be considered (e.g. by the apparatus) to be a potentially sensitive entity, if the entity is associated with the content and is at least considered (e.g. by the apparatus) to be not associated with the user (e.g. not known to the user).

Alternatively, an entity may for instance be considered (e.g. by the apparatus) to be a potentially sensitive entity, if the entity is associated with the content and is at least considered (e.g. by the apparatus) to be not associated with the user (e.g. not known to the user) and/or (e.g. at least generally) disagrees with sharing and/or publishing content representing the entity and/or at least a characteristic trait of the entity.

The user may set the criteria defining whether or not an entity is (e.g. from a perspective of the apparatus) potentially sensitive, but equally well default criteria may be applied. For instance, an administrator may pre-set default criteria for all users. Therein, the user may be able to select and deselect at least some criteria of the pre-set default criteria. However, the user may also not be able to select and deselect any criteria of the pre-set default criteria. For instance, the criteria may define a risk policy (e.g. a default risk policy and/or a user specific risk policy) which is applied by the apparatus to determine whether or not an entity is (to be considered to be) potentially sensitive. Non-limiting examples of such criteria are relationship of the user to the entity, privacy policy of the entity and position at which the content was captured. Potentially sensitive entities may for instance also be confidential objects, important buildings (e.g. power plants, bridges) and/or secret files.

An entity may for instance be understood to be associated with the user, if the entity is known to the user. A person may for instance be considered to be known to the user, if a database of the user (e.g. an address book or contact database, which may for instance be stored on the device) includes an entry corresponding to the person and/or if the person is one of the user's social network contacts. For instance, the user may set that only persons corresponding to an entry in an address book/contact database and/or the user's social network contacts are to be considered to be associated with the user by the apparatus. Otherwise, an entity may be considered to be not associated with the user by the apparatus.

An entity considered to be a potentially sensitive entity by the apparatus may in fact be a sensitive entity, a potentially sensitive entity or a non-sensitive entity.

For instance, a person (as an example of an entity) associated with the content may be known to the user, but may nevertheless be considered to be a potentially sensitive entity by the apparatus, if no information indicating that the person is known to the user is found by the apparatus (e.g. the person is not a social network contact of the user and there is also not a corresponding entry in the address book/contact database of the user stored on the device). Also, a person associated with the content may actually agree with publishing and/or storing the content, but may be considered to be a potentially sensitive entity by the apparatus, if no information indicating that the entity agrees with sharing and/or publishing the content is found by the apparatus. In cases where the potentially sensitive entity is known to the user and/or has given permission to share and/or publish the content, the user may for instance (e.g. manually) determine that the potentially sensitive entity in fact is a non-sensitive entity (e.g. confirm to share and/or publish the content as described below in more detail). In cases where the potentially sensitive entity has refused permission to share and/or publish the content, the user may determine that the potentially sensitive entity in fact is sensitive (e.g. not confirm to share and/or publish the content). In cases where the potentially sensitive entity is not known to the user and/or the user has no information indicating whether or not the potentially sensitive entity agrees with publishing and/or sharing the content, the user may determine that the potentially sensitive entity is in fact potentially sensitive.

The content may be determined to be associated with a potentially sensitive entity, if sharing and/or publishing of the content may potentially violate privacy of the potentially sensitive entity. Accordingly, the user may set criteria defining whether or not sharing and/or publishing of the content may potentially violate privacy of the potentially sensitive entity (e.g. a user-specific risk policy), but equally well default criteria may be applied (e.g. a default risk policy). As described in detail below (e.g. with respect to the fifth, sixth and eighth embodiments according to the invention), the determining may be based on analyzing the content and/or information (e.g. meta information) associated with the content and/or on exploiting information about the user of the device and/or about the potentially sensitive entity.

Sharing of the content may for instance be understood to relate to making the content at least available to a group of people, for instance a restricted group of people. For instance, the content may be made available to a (restricted) group of people by distributing the content via a distribution list of a private message service such as electronic-mail-service (Email), short-message-service (SMS) and multimedia-messaging-service (MMS). A (restricted) group of people may for instance be the user's contacts on a social network platform. By uploading the content to the social network platform (e.g. Facebook, LinkedIn and XING) the content may for instance only be made available to the user's contacts on the social network platform, if the user's profile on the social network platform is only accessible by the contacts. This may depend on the privacy settings of the user and/or the privacy policy of the social network platform.

Publishing of the content may for instance be understood to relate to making the content available to the public. Preferably, the content is understood to be made available to the public, if the content is accessible without any restrictions. By uploading the content to a public content-sharing platform (e.g. YouTube and Picasa) the content may for instance typically be made available to the public. However, by uploading the content to a private space (e.g. a private photo album) on a content-sharing platform, the content may for instance only be made available to a restricted group of people having access to the private space.

Sharing and/or publishing of the content may comprise transmitting the content from the device to one or more further devices, for instance from a communication interface of the device to a network element such as a server of a public platform.

Non-modally notifying a user should be understood to relate to notifying the user without requiring the user to confirm the notifying. Accordingly, the user may be notified that the content is associated with at least one potentially sensitive entity, and, independently of the (non-modal) notifying (e.g. without requiring the user to explicitly confirm sharing and/or publishing of the content), the content may be shared and/or published. The non-modal notifying may thus be performed before, during or after sharing and/or publishing the content. For instance, a non-modal dialog may be output (e.g. presented) to the user, for instance a pop-up window containing a corresponding warning may be displayed to the user. The non-modal notifying may allow the user to at least retroactively check whether or not the at least one potentially sensitive entity in fact is a potentially sensitive entity or a sensitive entity. For instance, the user may undo the sharing and/or publishing, if the user retroactively determines that the at least one potentially entity in fact is a potentially sensitive entity or a sensitive entity. This non-modal notifying is inter-alia advantageous in case that a computer program runs on the device which causes the device to automatically or semi-automatically share and/or publish content and/or in case that a large number of content is to be shared and/or published.

Preventing an at least unintentional sharing and/or publishing of the content may for instance comprise requiring the user to confirm sharing and/or publishing of the content, putting the content into quarantine and/or preventing the sharing and/or publishing at all as described below in more detail (e.g. with respect to the twelfth, thirteenth and fourteenth embodiment of the invention). If it is determined that the content is associated with at least one potentially sensitive entity, the user may for instance be modally notified that the content is associated with at least one potentially sensitive entity to prevent an at least unintentional sharing and/or publishing of the content. Modally notifying a user should be understood to relate to notifying the user and, additionally, requiring the user to confirm the notifying (for instance to confirm a message presented in the notifying). Accordingly, the user may be notified that the content (to be shared/published) is associated with at least one potentially sensitive entity, and the content may only be published and shared, if the user explicitly confirms the notification to cause the sharing and/or publishing of the content as described below (e.g. with respect to the twelfth embodiment of the invention). The modal notifying may thus preferably be performed before sharing and/or publishing the content. In particular the sharing and/or publishing of the content may only be performed, if the user explicitly confirms sharing and/or publishing of the content. For instance, a modal dialog may be output (e.g. presented) to the user, for instance a pop-up window containing a corresponding warning and a mandatory confirmation box may be displayed to the user. Only if the user checks the mandatory confirmation box, the content may for instance be shared and/or published. This modal notifying is inter-alia advantageous to (automatically) prevent the user from at least unintentionally sharing and/or publishing of content associated with potentially sensitive entities (e.g. persons, confidential objects, important buildings and/or secret files). If the user has been modally notified, a sharing/publishing of content may for instance no longer be considered unintentional.

For instance, the non-modal and modal notifying described above may be combined. For instance, the user may be non-modally or modally notified depending on the at least one potentially sensitive entity and/or on criteria defined by a risk policy applied by the apparatus. Also, the user may be modally notified, if the user is considered to ignore the non-modal notifying (e.g. if more non-modal warnings than a corresponding threshold value defined by a risk policy have been output/presented to the user).

Also, sharing and/or publishing of the content may for instance be prevented at all and/or the content may be put in quarantine, if it is determined that the content is associated with at least one potentially sensitive entity. Additionally, the user may be notified that the content is associated with at least one potentially sensitive entity and/or that the content is or has been put in quarantine and/or that the sharing and/or publishing is prevented at all.

Sharing and/or publishing of the content may for instance only be prevented at all, if it is determined that the content is associated with at least one potentially sensitive entity of a specific group of at least potentially sensitive entities as described in more detail below (e.g. with respect to the fourteenth embodiment of the invention). For instance, sharing and/or publishing may also be prevented at all, if the user has explicitly confirmed to share and/or publish the content. This is inter-alia advantageous to (automatically) prevent that content associated with potentially sensitive entities (e.g. persons, confidential objects, important buildings and/or secret files) is (e.g. intentionally) made public at all.

The content may for instance only be put in quarantine, if it is determined that the content is associated with at least one potentially sensitive entity of a specific group of at least potentially sensitive entities as described in more detail below (e.g. with respect to the thirteenth embodiment of the invention). This is inter-alia advantageous to (automatically) prevent that content associated with potentially sensitive entities (e.g. persons, confidential objects, important buildings and/or secret files) is at least unintentionally made public at all.

According to the first embodiment of the invention, the content may for instance be pre-processed by the apparatus and the user may only be notified and/or required to confirm the sharing and/or publishing, if it is determined that the content is associated with at least one potentially sensitive entity (e.g. based on a risk policy applied by the apparatus as described above). Thus, the invention is inter-alia advantageous in view of user experience and processing speed, because (for instance automatic or semi-automatic) sharing and/or publishing of the content may only be interrupted, if it is determined that the content is associated with at least one potentially sensitive entity.

Furthermore, the present invention is inter-alia advantageous in cases where the content can not be effectively handled by the user, which may for instance be the case, if one or more databases have to be searched or if the number of content to be shared and/or published (e.g. the number of data container containing the content) exceeds 10, preferably 100, more preferably 1000, even more preferably 10000. According to the first embodiment of the invention, such a (large) amount of content may for instance be automatically pre-processed and shared and/or published, wherein a user interaction may only be required, if a specific content of the large number of content is determined (e.g. by the apparatus performing the pre-processing) to be associated with at least one potentially sensitive entity. The invention thus allows to filter content associated with at least one potentially sensitive entity out of a (large) number of content to be shared and/or published and, thus, enables the user to effectively handle the (large) number of content.

The method according to the first embodiment of the invention may for instance at least partially be performed by an apparatus, for instance by an apparatus according to the first embodiment of the invention as described below. The apparatus may be or form part of the device, but may equally well not be part of the device. The apparatus may be a portable user device.

An apparatus according to the first embodiment of the invention comprises means for performing the method according to the first embodiment of the invention or respective means for performing the respective method steps according to the first embodiment of the invention. The means may for instance be implemented in hardware and/or software. They may comprise a processor configured to execute computer program code to realize the required functions, a memory storing the program code, or both. Alternatively, they could comprise for instance circuitry that is designed to realize the required functions, for instance implemented in a chipset or a chip, like an integrated circuit. Further alternatively, the means could be functional modules of a computer program code.

A further apparatus according to the first embodiment of the invention comprises at least one processor; and at least one memory including computer program code (e.g. for one or more programs), the at least one memory and the computer program code configured to, with the at least one processor, cause the apparatus at least to perform the method according to the first embodiment of the invention.

A computer program according to the first embodiment of the invention comprises computer program code (e.g. one or more sequence of one or more instructions) configured to cause an apparatus to perform the method according to the first embodiment of the invention when the computer program is executed on at least one processor. Furthermore, the computer program may also comprise computer program code configured to cause the apparatus to automatically or semi-automatically share and/or publish content, when the computer program is executed on the at least one processor. A computer program may preferably be understood to run on an apparatus, when the computer program is executed on at least one processor of the apparatus.

The computer program may for instance be distributable via a network, such as for instance the Internet. The computer program may for instance be storable or encodable in a computer-readable medium. The computer program may for instance at least partially represent software and/or firmware of the device.

A computer-readable medium according to the first embodiment of the invention has the computer program according to the first embodiment of the invention stored thereon. The computer-readable medium may for instance be embodied as an electric, magnetic, electro-magnetic, optic or other storage medium, and may either be a removable medium or a medium that is fixedly installed in an apparatus or device. Non-limiting examples of such a computer-readable medium are a Random-Access Memory (RAM) or a Read-Only Memory (ROM). The computer-readable medium may for instance be a tangible medium, for instance a tangible storage medium. A computer-readable medium is understood to be readable by a computer, such as for instance a processor.

In the following, example features and embodiments (exhibiting further features) of the invention will be described, which are understood to equally apply at least to the apparatus, method, computer program and computer-readable medium according to the first embodiment of the invention as described above. These single features/embodiments are considered to be exemplary and non-limiting, and to be respectively combinable independently from other disclosed features/embodiments according to the invention. Nevertheless, these features/embodiments shall also be considered to be disclosed in all possible combinations with each other and with the apparatus, method, computer program and computer-readable medium according to the first embodiment of the invention as described above. Furthermore, a mentioning of a method step should be understood to also disclose that an apparatus performs (or is configured or arranged to perform) a corresponding action and a corresponding program code of the computer program.

In a second embodiment of the invention, the first embodiment of the invention comprises the feature that the content represents one or more characteristic traits of the least one potentially sensitive entity. As described above (e.g. with respect to the first embodiment of the invention), non-limiting examples of a characteristic trait of an entity are the face/voice of a person or an identification of an object such as a license plate of a vehicle.

In a third embodiment of the invention, the embodiments of the invention described above comprise the feature that the at least one potentially sensitive entity is associated with the content and is at least considered (e.g. by the apparatus) to be not associated with the user. An entity may preferably be understood to be associated with the user, if the entity is known to the user. A person (as an example of an entity) may for instance be considered to be known to the user, if an address book/contact database of the user includes an entry corresponding to the person and/or if the person is one of the user's social network contacts. For instance, the user may set that only persons corresponding to an entry in an address book/contact database and/or the user's social network contacts are to be considered to be associated with the user. Otherwise, an entity may be considered to be not associated with the user. A person may for instance be considered to be a potentially sensitive entity by the apparatus, if the entity is associated with the content and is at least considered to be not associated with the user (e.g. not known to the user). Alternatively or additionally, further criteria may be used to determine whether or not a person is to be considered to be potentially sensitive as described above (e.g. with respect to the first embodiment of the invention). For instance, a risk policy (e.g. a default risk policy and/or a user specific risk policy) which is used/applied by the apparatus to determine whether or not an entity is to be considered to be potentially sensitive may define these criteria.

In a fourth embodiment of the invention, the embodiments of the invention described above comprise the feature that the at least one potentially sensitive entity at least generally disagrees with sharing and/or publishing the content.

In a fifth embodiment of the invention, the embodiments of the invention described above comprise the feature that the determining comprises identifying one or more entities associated with the content, and checking whether or not at least one entity of the entities identified to be associated with the content is potentially sensitive.

As described above (e.g. with respect to the first embodiment of the invention), an entity may be understood to be associated with the content, if the content at least potentially represents a characteristic trait of the entity. Accordingly, an entity may be identified to be associated with the content, if the content represents a characteristic trait of the entity and/or if the content at least potentially represents a characteristic trait of the entity. In the former case, the entity may for instance be (directly) identified by analyzing the content. In the latter case, the entity may for instance also be (indirectly) identified by analyzing information (e.g. meta information) associated with the content, for instance information about the time when the content was captured and/or the position/proximity at which the content was captured. Directly identifying the entities may be more precise than indirectly identifying the entities, but may also be more computationally intensive.

For each of the entities identified to be associated with the content, it may then be checked whether or not the entity is potentially sensitive. For instance, it may be checked whether or not each of the entities is known to the user and/or whether or not each of the entities (e.g. generally) agrees with sharing and/or publishing content representing the entity and/or a characteristic trait of the entity.

In a sixth embodiment of the invention, the embodiments of the invention described above comprise the feature that the determining is at least partially based on analyzing information associated with the content. The information may preferably be captured when the content is captured (e.g. shortly before, simultaneously with or shortly after capturing the content). The information may for instance be meta information embedded in a data container also containing the content. For instance, the meta information may be information according to an Exchangeable Image File Format (EXIF) standard.

The information may comprise position information, timestamp information, user information (e.g. a user tag) and/or proximity information. As described above (e.g. with respect to the fifth embodiment of the invention), analyzing this information allows to indirectly identify entities at least potentially associated with the content. This embodiment is inter-alia advantageous for (mobile) devices with limited computational capabilities.

The timestamp information may indicate the time when the content was captured.

The position information may indicate at which position the content was captured. The position information may for instance comprise coordinates of a satellite navigation system such as for instance the global positioning system (GPS). The position information may for instance comprise coverage area identifier information of wireless communication systems detectable at the position at which the content was captured (e.g. a Service Set Identifier (SSID) of a WLAN system, a Media Access Control (MAC) address of a communication device and/or a Cell ID of a GSM system). Based on such coverage area identifier information the position at which the content was captured may at least be determined to be within the corresponding coverage area. For instance, a position database (e.g. a social network platform) may be searched for entities which were at the position indicated by the position information when the content was captured. This is inter-alia advantageous, because most content capturing devices (e.g. digital cameras and mobile phones) nowadays, when capturing content, also capture position information.

The proximity information may comprise information about entities which were in proximity when the content was captured and, thus, may at least potentially be associated with the content. The proximity information may comprise (e.g. unique) device identifier information identifying devices communicating in a wireless communication system, preferably in a low range wireless communication system (e.g. Bluetooth, RFID and NFC). In particular, the proximity information may comprise device identifier information received at a position at which the content was captured when the content was captured. For instance, the device identifier information may be received at a communication interface of the device by scanning low range wireless communication systems when the content is captured by the content capturing component. Based on this proximity information, the determining (preferably the identifying and/or checking of the fifth embodiment of the invention) may be performed.

In particular, it may be determined that the content is associated with at least one potentially sensitive entity, if at least one entity associated with (e.g. linkable to) at least one device of the devices identified by the device identifier information is not associated with the user. Therein, the at least one entity associated with at least one device of the devices identified by the device identifier information may be the at least one potentially sensitive entity.

The determining may comprise searching the device identifier information in contact information stored in a local database on the device and/or in a remote database on a network element, for instance in an address book/contact database of the user, in an operator database and/or in social network information of social network contacts of the user. For instance, a device identifier database (e.g. an operator database, a social network database and/or an address book/contact database) may be searched for entities associated with received device identifier information and associated with the user. For instance, a locally and/or remotely stored address book/contact database of the user may be searched and/or the user's social network contacts may be searched. This is inter-alia advantageous, because most content capturing devices (e.g. digital cameras and mobile phones) nowadays are also capable of communicating in low range wireless communication systems.

In a seventh embodiment of the invention, the embodiments of the invention described above comprise the feature that the determining is at least performed and/or it is determined that the content is associated with at least one potentially sensitive entity, if the content was captured in a sensitive space (e.g. a public space or a restricted area). As described above (e.g. with respect to the first embodiment of the invention), the user may set criteria defining whether or not sharing and/or publishing of the content may potentially violate privacy of the potentially sensitive entity. One such criterion may be the position at which the content was captured. In case that the content was captured in a private/residential space (e.g. at the user's home), it may for instance be assumed that any entity associated with the content agrees with sharing and/or publishing the content. In this case, the determining may be skipped and/or it may be (e.g. automatically) determined that the content is not associated with at least one potentially sensitive entity. In case that the content was captured in a public space, the content may at least potentially be associated with a potentially sensitive entity and the determining may accordingly be performed and/or it may be (e.g. automatically) determined that the content is associated with at least one potentially sensitive entity.

In case that the content was captured in a restricted area, it may preferably be (automatically) determined that the content is associated with at least one potentially sensitive entity. In this case, sharing and/or publishing of the content may for instance be prevented at all. For instance, a risk policy applied by the apparatus may define that sharing and/or publishing of content captured in a restricted area is to be prevented at all.

This embodiment is inter-alia advantageous to provide a simple criterion for deciding whether or not the content is associated with at least one potentially sensitive entity.

In an eighth embodiment of the invention, the embodiments of the invention described above comprise the feature that the determining is at least partially based on analyzing the content. As described above (e.g. with respect to the fifth embodiment of the invention), analyzing the content allows to directly identify entities associated with the content. This embodiment is inter-alia advantageous to precisely identify entities actually associated with the content. For instance, it may be analyzed whether or not the content represents an entity and/or a characteristic trait of an entity. Non-limiting examples of a characteristic trait of a person are the face and/or the voice of the person.

In a ninth embodiment of the invention, the embodiments of the invention described above comprise the feature that the analyzing comprises image recognition and/or audio recognition such as pattern recognition, character recognition voice recognition and/or facial recognition.

Based on image recognition and/or audio recognition the determining (preferably the identifying and/or checking of the fifth embodiment of the invention) may be performed. In particular, it may be determined that the content is associated with at least one potentially sensitive entity, if at least one entity recognized by the image recognition and/or the audio recognition is at least considered to be not associated with the user. An entity may preferably be understood to be recognized by the image recognition and/or the audio recognition, if one or more characteristic traits of the entity are recognized thereby.

If the content comprises visual content (e.g. an image, a picture, a photo, a video, a video recoding), the analyzing may for instance comprise image recognition such as visual pattern recognition, character recognition and/or facial recognition. Based on visual pattern recognition/character recognition/face recognition, characteristic traits of entities and/or entities represented by the image may be recognized. The visual pattern recognition, character recognition and/or facial recognition may for instance be based on rules such that predefined characteristic traits of entities represented by the content are recognized.

The predefined characteristic traits may relate to a general class of characteristic traits such as faces and/or license plates. For instance, the facial recognition may allow to recognize all faces represented by the image. As described above (e.g. with respect to the first embodiment of the invention), an entity may be understood to be associated with the content, if the content represents a characteristic trait of the entity. Accordingly, all persons whose faces are recognized to be represented by the image are identified to be associated with the image.

A predefined characteristic trait may also relate to a characteristic trait of a specific (e.g. sensitive) entity such as the face of a specific person, a brand name, a logo, a company name, a license plate, etc. In a privacy policy database, characteristic trait information of sensitive entities disagreeing with publishing and/or sharing content representing the entity may for instance be stored. Based on this characteristic trait information, corresponding characteristic traits of entities represented by the image may be recognized by visual pattern recognition and/or facial recognition.

In case that the entity recognized by the image recognition is a person, the determining may comprise searching the face of the person (e.g. recognized by the facial recognition) in portrait images stored in an address book/contact database of the user and/or in portrait images of social network contacts of the user. For instance, a locally and/or remotely stored address book/contact database of the user may be searched and/or the user's social network contacts may be searched.

If the content comprises audio content (e.g. an audio recording, a recoding of a conversation, an audio track of a video recording), the analyzing may comprise audio recognition such as acoustical pattern recognition and/or voice recognition. Based on acoustical pattern recognition and/or voice recognition, characteristic traits of entities and/or entities represented by the audio recording may be recognized. The acoustical pattern recognition and/or voice recognition may for instance be based on rules such that predefined characteristic traits of entities represented by the content are recognized.

The predefined characteristic traits may relate to a general class of characteristic traits such as voices. For instance, the voice recognition may allow to recognize all voices represented by the audio recording. As described above (e.g. with respect to the first embodiment of the invention), an entity may be understood to be associated with the content, if the content represents a characteristic trait of the entity. Accordingly, all persons whose voices are recognized to be represented by the audio recoding are identified to be associated with the audio recoding.

A predefined characteristic trait may also relate to a characteristic trait of a specific (e.g. sensitive) entity such as the voice of a specific person, a sound track, etc. In a privacy policy database, characteristic trait information of sensitive entities disagreeing with publishing and/or sharing content representing the entity may for instance be stored. Based on this characteristic trait information corresponding characteristic traits of entities represented by the image may be recognized by acoustical pattern recognition and/or voice recognition.

In a tenth embodiment of the invention, the embodiments of the invention described above comprise the feature that the determining (preferably the identifying and/or checking of the fifth embodiment of the invention) is at least partially based on (e.g. exploiting) information about the user of the device and/or on (e.g. exploiting) information about the at least one entity and/or the entities identified to be associated with the content. The information may for instance be locally and/or remotely stored. Based on this information, it may for instance be checked (e.g. by the apparatus) whether or not at least one entity of the entities identified to be associated with the content is (to be considered to be) potentially sensitive. This embodiment is inter-alia advantageous to check whether or not an entity is potentially sensitive. For instance, an address book/contact database and/or a database of social network platform may be searched. The search key may for instance a name of the at least one potentially sensitive entity, a characteristic trait of the at least one potentially sensitive entity, a telephone number, device identifier information, a portrait image etc.

The information about the user of the device and/or about the at least one entity and/or the entities may be contact information (e.g. address book information), privacy information and/or social network information (e.g. social network profile information).

As described above, based on this information, it may for instance be checked whether or not at least one entity of the entities identified to be associated with the content is potentially sensitive. For instance, it may be checked whether or not the entity is known to the user and/or (e.g. generally) agrees with sharing and/or publishing content representing the entity and/or one or more characteristic traits of the entity. The checking may for instance be based on criteria defined by a (e.g. default and/or user specific) risk policy as described above (e.g. with respect to the first embodiment of the invention).

In case that a person is identified to be an entity associated with the content, a locally and/or remotely stored address book/contact database of the user may be searched for the person and/or the user's social network contacts may be searched for the person. In case that the person has been identified to be represented by the content by facial recognition, for instance the recognized face of the person may be compared with portrait images stored in the address book/contact database and/or portrait images (e.g. profile images) of the social network contacts as described above (e.g. with respect to the ninth embodiment of the invention). The user's social network contacts may for instance be remotely stored on a server of the social network platform and/or locally on the device.

Also, an entity identified by a first search may be further searched based on the results of the first search. For instance, an entity may be firstly found in an address book/contact database and may be then searched based on the information stored in the address book/contact database in a further database (e.g. on a social network platform).

Also, a privacy policy database may be searched for the person. For instance, a database entry resulting from the search may indicate whether or not the person disagrees with sharing and/or publishing content representing the person and/or one or more characteristic traits of the person and/or under which conditions the person agrees therewith. For instance, a person may only agree with sharing and/or publishing content representing the person, if the content is only made available to a restricted group of people and/or to people known to the person.

This embodiment allows to check whether or not an entity is potentially sensitive based on already existing information such as contact information and/or social network information. This is inter-alia advantageous, because it can be easily implemented in mobile devices having access to local and/or remote databases such as address book/contact databases of the user and/or the user's social network contacts.

The information about the user of the device and/or about the at least one entity and/or the entities may be stored (locally) on the device and/or (remotely) on a network element such as a server.

In an eleventh embodiment of the invention, the embodiments of the invention described above comprise the feature that at least a characteristic trait of the least one potentially sensitive entity represented by the content is blurred and/or distorted (e.g. the method according to the first embodiment of the invention further comprises blurring and/or distorting at least a characteristic trait of the at least one potentially sensitive entity represented by the content).

For instance, the preventing an at least unintentional sharing and/or publishing may comprise the blurring and/or distorting of at least a part of the content. Blurring may preferably be understood to relate to adding noise to the content such that the content is at least partially made unidentifiable (e.g. the characteristic trait of the least one potentially sensitive entity represented by the content is made unidentifiable). For instance, the user may request to blur a characteristic trait of the least one potentially sensitive entity. Alternatively or additionally, a characteristic trait of the least one potentially sensitive entity may automatically be blurred before sharing and/or publishing the content. In particular, characteristic traits of sensitive entities disagreeing with sharing and/or publishing content representing the entity and/or one or more characteristic traits of the entity may be automatically blurred and/or distorted. For instance, characteristic traits of such sensitive entities identified by visual pattern recognition and/or face recognition may be automatically blurred. For instance, a risk policy applied by the apparatus may define that characteristic traits of sensitive entities disagreeing with sharing and/or publishing content representing the entity and/or one or more characteristic traits of the entity are to be automatically blurred and/or distorted.

This embodiment is inter-alia advantageous to allow the user to share and/or publish the content without violating privacy of the at least one potentially sensitive entity.

In a twelfth embodiment of the invention, the embodiments of the invention described above comprise the feature that preventing an at least unintentional sharing and/or publishing comprises requiring the user to explicitly confirm sharing and/or publishing of the content. For instance, the content may only be shared and/or published, if the user confirms to share and/or publish the content (e.g. confirms a notification that the content to be shared/published is associated with at least one potentially sensitive entity and is only shared/published upon a confirmation from the user). For instance, the preventing an at least unintentional sharing and/or publishing comprises modally notifying the user that the content is associated with at least one potentially sensitive entity. For instance, a modal dialog may be output (e.g. presented) to the user, for instance a pop-up window containing a corresponding warning and a mandatory confirmation box may be displayed to the user. Only if the user checks the mandatory confirmation box, the content may for instance be shared and/or published.

For instance, the content may be displayed on the user interface of the device and the characteristic traits of the at least one sensitive entity identified by visual pattern recognition and/or face recognition may be highlighted such that the user can decide whether or not the at least one potentially sensitive entity in fact is sensitive. For instance, the user may be required to explicitly confirm sharing and/or publishing of the content. For instance, the user may request to blur a characteristic trait of the least one potentially sensitive entity represented by the content as described above (e.g. with respect to the eleventh embodiment of the invention) before confirming sharing and/or publishing the content. This embodiment is inter-alia advantageous in case that the determining is triggered by an action directed to share and/or publish the content performed by the user.

In a thirteenth embodiment of the invention, the embodiments of the invention described above comprise the feature that preventing an at least unintentional sharing and/or publishing comprises putting the content in quarantine. In case that a computer program runs on the device which causes the device to automatically share and/or publish content on a social network platform, the content determined to be associated with at least one potentially sensitive entity may for instance be uploaded to a quarantine space on the social network platform to which access is restricted. The user may be notified correspondingly, but may not be required to confirm sharing and/or publishing of the content directly (e.g. the user may be non-modally notified as described above in more detail). However, the user may for instance be required to explicitly confirm releasing the content from quarantine to share and/or publish the content. Accordingly, the automatically sharing and/or publishing may be not interrupted.

The content may for instance only be put in quarantine, if it is determined that the content is associated with at least one potentially sensitive entity of a specific group of at least potentially sensitive entities such as entities (e.g. explicitly) disagreeing with sharing and/or publishing content at least partially representing them. For instance, the specific group of at least potentially sensitive entities may be defined by a risk policy applied by the apparatus.

This embodiment is inter-alia advantageous in case that a computer program runs on the device which causes the device to automatically or semi-automatically share and/or publish content and/or in case that a large number of content is to be shared and/or published.

In a fourteenth embodiment of the invention, the embodiments of the invention described above comprise the feature that preventing an at least unintentional sharing and/or publishing comprises preventing sharing and/or publishing of the content at all. For instance, uploading and/or transmitting of the content may be blocked.

Sharing and/or publishing of the content may for instance only be prevented at all, if it is determined that the content is associated with at least one potentially sensitive entity of a specific group of at least potentially sensitive entities such as entities (e.g. explicitly) disagreeing with sharing and/or publishing content at least partially representing them. For instance, the specific group of at least potentially sensitive entities may be defined by a risk policy applied by the apparatus. For instance, sharing and/or publishing of the content may also be prevented at all, if the user has explicitly confirmed to share and/or publish the content.

This embodiment is inter-alia advantageous to (automatically) prevent that content associated with potentially sensitive entities (e.g. persons, confidential objects, important buildings and/or secret files) is (e.g. intentionally) made public at all.

In a sixteenth embodiment of the invention, the embodiments of the invention described above comprise the feature that the determining is (e.g. automatically) triggered by an action directed to sharing and/or publishing the content. The action may preferably be performed by the user. The action may for instance correspond to a user input at a user interface of the device to share and/or publish the content. The action may for instance relate to pushing a button on a keyboard and/or touching a specific portion of a touch-screen. For instance, the user may request to upload the content to a social network platform and/or a content-sharing platform. For instance, the action may trigger the determining such that the content is only shared and/or published, if it is determined that the content is not associated with at least one potentially sensitive entity. Otherwise, an at least unintentional sharing and/or publishing of the content may be prevented. Alternatively or additionally, the user may be non-modally notified that the content is associated with at least one potentially sensitive entity, if it is determined that the content is associated with at least one potentially sensitive entity.

Alternatively or additionally, the determining may be periodically (e.g. automatically) triggered and/or the determining may be (e.g. automatically) triggered, when the content is obtained at the apparatus. For instance, the determining may be periodically performed for content (e.g. newly) obtained at the apparatus. For instance, the determining may be performed for content, when the content is obtained at the apparatus. In this cases, non-modally notifying a user that the content is associated with at least one potentially sensitive entity and/or preventing an at least unintentional sharing and/or publishing of the content by a user of the device may be triggered by an action directed to sharing and/or publishing the content and is only performed, if it has been determined that the content is associated with at least one potentially sensitive entity. For instance, information whether or not the content is associated with at least one potentially sensitive entity (e.g. resulting from the determining) may be associated with the content. This information may for instance be meta information embedded in a data container also containing the content (e.g. as described above with respect to the sixth embodiment of the invention).

For instance, the non-modal notifying a user that the content is associated with at least one potentially sensitive entity and/or the preventing an at least unintentional sharing and/or publishing of the content by a user of the device may be triggered by an action directed to sharing and/or publishing the content and is only performed, if information indicating that the content is associated with at least one potentially sensitive entity is associated with the content.

In a seventeenth embodiment of the invention, the embodiments of the invention described above comprise the feature that the apparatus and/or the device further comprises at least one of a user interface, an antenna and communication interface.

The user interface may be configured to output (e.g. present) user information to the user of the device and/or to capture user input from the user. The user interface may be a standard user interface of the device via which the user interacts with the device to control functionality thereof; such as making phone calls, browsing the Internet, etc. The user interface may for instance comprise a display, a keyboard, an alphanumeric keyboard, a numeric keyboard, a camera, a microphone, a speaker, a touchpad, a mouse and/or a touch-screen.

The communication interface of the device may for instance be configured to receive and/or transmit information via one or more wireless and/or wire-bound communication systems. Non limiting examples of wireless communication systems are a cellular radio communication system (e.g. a Global System for Mobile Communications (GSM), a Universal Mobile Telecommunications System (UMTS), a Long-Term-Evolution (LTE) system) and a non-cellular radio communication system (e.g. a wireless local area network (WLAN) system, a Worldwide Interoperability for Microwave Access (WiMAX) system, a Bluetooth system, a radio-frequency identification (RFID) system, a Near Field Communication (NFC) system). Non limiting examples of wire-bound communication systems are an Ethernet system, a Universal Serial Bus (USB) system and a Firewire system.

In an eighteenth embodiment of the invention, the embodiments of the invention described above comprise the feature that the apparatus is or forms part of the device.

In a nineteenth embodiment of the invention, the embodiments of the invention described above comprise the feature that the apparatus is a user device, preferably a portable user device. A user device is preferably to be understood to relate to a user equipment device, a handheld device and/or a mobile device. This embodiment is inter-alia advantageous since the non-modal notifying a user and/or the preventing an at least unintentional sharing and/or publishing is performed in the user's sphere without involving any third party (e.g. an operator of a social network platform).

Other features of the invention will be apparent from and elucidated with reference to the detailed description presented hereinafter in conjunction with the accompanying drawings. It is to be understood, however, that the drawings are designed solely for purposes of illustration and not as a definition of the limits of the invention, for which reference should be made to the appended claims.

It should further be understood that the drawings are not drawn to scale and that they are merely intended to conceptually illustrate the structures and procedures described therein. In particular, presence of features in the drawings should not be considered to render these features mandatory for the invention.

### BRIEF DESCRIPTION OF THE FIGURES

In the figures show:

FIG. 1a: a schematic block diagram of an example embodiment of a system according to the invention;

FIG. 1b: a schematic illustration of an exemplary situation in which an image is captured according to the invention;

FIG. 2: a schematic block diagram of an example embodiment of an apparatus according to the invention;

FIG. 3: a schematic illustration of an example embodiment of a tangible storage medium according to the invention;

FIG. 4: a flowchart of an exemplary embodiment of a method according to the invention;

FIG. 5: a flowchart of another exemplary embodiment of a method according to the invention;

FIG. 6: a flowchart of another exemplary embodiment of a method according to the invention; and

FIG. 7: a flowchart of another exemplary embodiment of a method according to the invention.

### DETAILED DESCRIPTION OF EMBODIMENTS OF THE INVENTION

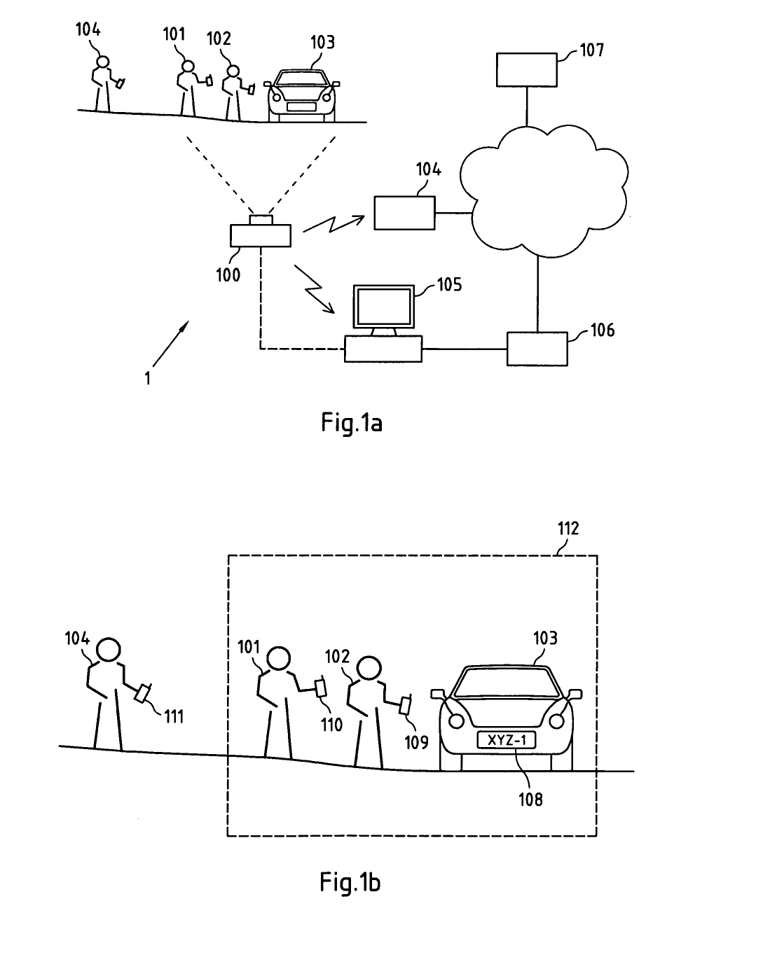

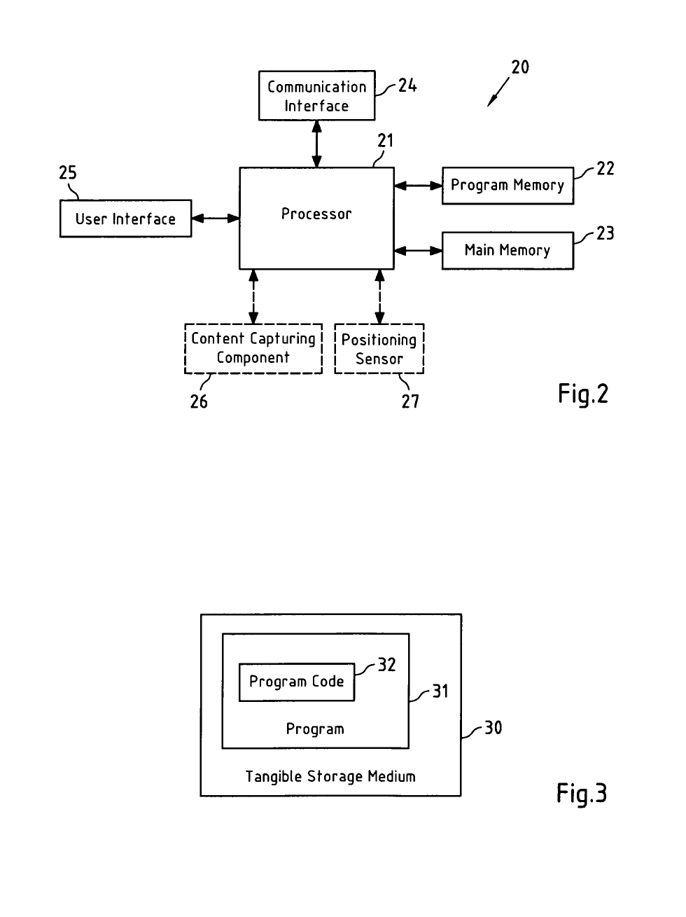

FIG. 1a is a schematic illustration of an example embodiment of system 1 according to the invention. System 1 comprises a content capturing device 100 such as a digital camera or a mobile phone. Content capturing device 100 may correspond to apparatus 20 as described below with respect to FIG. 2. Content capturing device 100 is configured to capture an image such as image 112 representing entities 101-103 as described below with respect to FIG. 1b.

Furthermore, content capturing device 100 may be configured to transmit (e.g. upload) the captured image via a wireless connection to server 104. For instance, content capturing device 100 may be configured to transmit the captured image via a wireless connection of a cellular radio communication system to server 104. For instance, the user of content capturing device 100 may initiate that the image is transmitted to server 104, but equally well the image may be automatically transmitted to server 104.

Also, content capturing device 100 may be configured to transmit (e.g. upload) the captured image via a wireless and/or wirebound connection to a personal computer 105 (e.g. a mobile computer). Personal computer 105 may correspond to apparatus 20 as described below with respect to FIG. 2. For instance, content capturing device 100 may be configured to transmit the captured image via a wireless connection of a WLAN system and/or a wirebound connection of an USB System to personal computer 105. From personal computer 105, the image may be then transmitted to server 106, for instance via an interne connection. For instance, the user of content capturing device 100 may initiate that the image is transmitted to personal computer 105 and/or to server 106, but equally well the image may be automatically transmitted to personal computer 105 and/or to server 106 via an internet connection.

Server 104 and/or 106 is a server of a social network platform on which the image may be shared and/or published such that the image may for instance be made available to a restricted group of people or to the public. For instance, social network contacts of the user of content capturing device 100 may access the captured image on server 104 and/or 106 via an internet connection. For instance, a user of personal computer 107 who is a social network contact of the user of content capturing device 100 may access the captured image on server 104 and/or 106. The image (or content in general) may also be shared with neighbouring devices and/or published in a peer-to-peer wireless manner without involving any access to the infrastructure/Internet at all (e.g. via a low range wireless communication system, such as Near Field Communication (NFC) or Bluetooth, to name but a few examples).

FIG. 1b is a schematic illustration of an exemplary situation in which image 112 is captured according to the invention. Image 112 may be a still image inter-alia representing entities 101, 102 and 103 and is for instance captured by content capturing device 100 of FIG. 1 and/or optional content capturing component 26 of apparatus 20 as described below with respect to FIG. 2. As apparent from FIG. 1b, entity 104 is in proximity when image 112 is captured, but is not represented by content 112. For instance, entity 104 is outside the field of vision of optional content capturing component 26 of apparatus 20 when image 112 is captured. Entity 103 is a car having a license plate 108, and entities 101, 102 and 104 are natural persons carrying mobile devices 109, 110 and 111, respectively. Persons 101 and 102 are connected with the user of content capturing device 100 and/or apparatus 20 on a social network platform.

FIG. 2 is a schematic block diagram of an example embodiment of an apparatus 20 according to the invention.

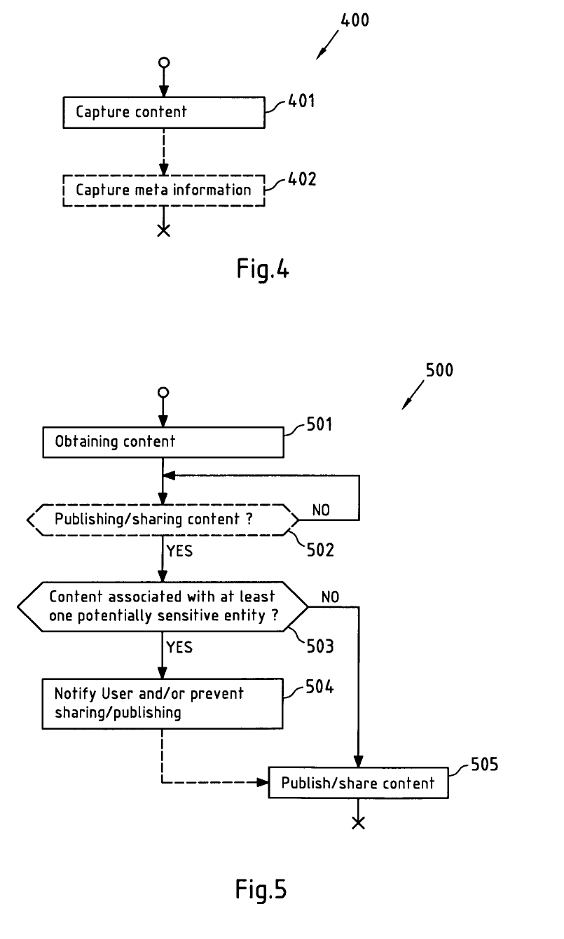

Apparatus 20 comprises a processor 21, which may for instance be embodied as a microprocessor, Digital Signal Processor (DSP) or Application Specific Integrated Circuit (ASIC), to name but a few non-limiting examples. Processor 21 executes a program code stored in program memory 22 (for instance program code implementing one or more of the embodiments of a method according to the invention described below with reference to FIGS. 4-7), and interfaces with a main memory 23 for instance to store temporary data. Some or all of memories 22 and 23 may also be included into processor 21. Memory 22 and/or 23 may for instance be embodied as Read-Only Memory (ROM), Random Access Memory (RAM), to name but a few non-limiting examples. One of or both of memories 22 and 23 may be fixedly connected to processor 21 or removable from processor 21, for instance in the form of a memory card or stick.

Processor 21 further controls a communication interface 24 configured to receive and/or transmit information via one or more wireless and/or wire-bound communication systems. Communication interface 24 may thus for instance comprise circuitry such as modulators, filters, mixers, switches and/or one or more antennas to allow transmission and/or reception of signals. Communication interface 24 may preferably be configured to allow communication according to cellular radio communication systems (e.g. a GSM system, UMTS, a LTE system, etc.) and/or non-cellular radio communication systems (e.g. a WLAN system, a WiMAX system, a Bluetooth system, a RFID system, a NFC system, etc.).

Processor 21 further controls a user interface 25 configured to output (e.g. present) user information to a user of apparatus 20 and/or to capture user input from such a user. User interface 25 may for instance be the standard user interface via which a user of interacts with apparatus 20 to control functionality thereof, such as making phone calls, browsing the Internet, etc.

Processor 21 may further control an optional content capturing component 26 comprising an optical and/or acoustical sensor, for instance a camera and/or a microphone. An optical sensor may for instance be an active pixel sensor (APS) and/or a charge-coupled device (CCD) sensor. Furthermore processor 21 may also control an optional position sensor 27 such as a GPS sensor. Optional content capturing component 26 and optional position sensor 27 may be attached to or integrated in apparatus 20.

FIG. 3 is a schematic illustration of an embodiment of a tangible storage medium 30 according to the invention. This tangible storage medium 30, which may in particular be a non-transitory storage medium, comprises a program 31, which in turn comprises program code 32 (for instance a set of instructions). Realizations of tangible storage medium 30 may for instance be program memory 22 of FIG. 2. Consequently, program code 32 may for instance implement the flowcharts of FIGS. 4-7 discussed below.

In the following, FIGS. 4-7 are described relating to flowcharts of example embodiments of the invention. For illustrative purposes only and without limiting the scope of the invention, it is assumed that the steps of the flowcharts of FIGS. 4-7 are performed by apparatus 20 (see FIG. 2). A step performed by apparatus 20 may preferably be understood such that corresponding program code is stored in memory 22 and that the program code and the memory are configured to, with processor 21, cause apparatus 20 to perform the step.

FIG. 4 is a flowchart 400 of an exemplary embodiment of a method according to the invention. Flowchart 400 basically relates to capturing content.

In step 401, content is captured by optional content capturing component 26 of apparatus 20. The content may be image 112 as described above with respect to FIG. 1b. In the exemplary situation of FIG. 1b, optional content capturing component 26 comprises at least an optical sensor configured to capture still images such as image 112. Captured image 112 may be then stored in a data container according to a JPEG format in memory 22 and/or memory 23 of apparatus 20.

In optional step 402, meta information associated with the content captured in step 401 are captured by apparatus 20. Optional step 402 may preferably be performed (shortly) before, simultaneously with or (shortly) after step 401.

As described above, the meta information may comprise position information, timestamp information, user information and/or proximity information. The meta information may be embedded in the data container also containing the captured content in memory 22 of apparatus 20. For instance, the meta information may be information according to an EXIF standard.

In the exemplary situation of FIG. 1b, optional position sensor 27 of apparatus 20 may for instance capture coordinates of the GPS system representing the position at which image 112 was captured. This position information may be embedded in the data container also containing image 112.

In the exemplary situation of FIG. 1 b, communication interface 24 of apparatus 20 may also scan low range wireless communication systems such as Bluetooth for device identifier information. For instance, apparatus 20 may receive, at communication interface 24, Bluetooth device identifier information from each of the mobile devices 109, 110 and 111 carried by entities 101, 102 and 104, respectively. The received Bluetooth device identifier information may also be embedded in the data container also containing image 112.

FIG. 5 is a flowchart 500 of an exemplary embodiment of a method according to the invention. Flowchart 500 basically relates to sharing and/or publishing content.

In step 501, content is obtained at apparatus 20 of FIG. 2. For instance, the content may be obtained as described above with respect to flowchart 400 of FIG. 4. Also, the content may for instance be received at communication interface 24 of apparatus 20. As described above, the content may be audio content and/or visual content. Non limiting examples of content are a still image, moving images, an audio recording, or a Bluetooth or network identifier (MAC and/or IP address) linkable to the sensitive entity. The content may be contained in a data container according to a standard data format such as a JPEG format and a MPEG format. The content may for instance be image 112 of FIG. 1b.

In step 502, it is determined whether or not the content is to be published and/or shared. In particular, it may be determined whether or not a user of apparatus 20 performed an action directed to sharing and/or publishing the content. For instance, the user may input on user interface 25 of apparatus 20 a request to share and/or publish the content. Furthermore, it may also be determined whether or nor the content is to be shared and/or published automatically.

As described above, sharing and/or publishing of the content may for instance be understood to relate to making the content at least available to a restricted group of people and/or to the public By uploading the content to a social network platform (e.g. Facebook, LinkedIn and XING) and/or to a content-sharing platform (e.g. YouTube and Picasa) the content may for instance be made available to a restricted group of people or to the public depending on the privacy settings of the user and the privacy policy of the respective platform.

Only if it is determined that the content is to be shared and/or published, flowchart 500 proceeds to step 503.

In step 503, it is determined whether or not the content is associated with at least one potentially sensitive entity. As described above, the content may be determined to be associated with a potentially sensitive entity, if sharing and/or publishing of the content may potentially violate privacy of the potentially sensitive entity.

The user of apparatus 20 may set criteria defining whether or not sharing and/or publishing of the content may potentially violate privacy of the potentially sensitive entity (e.g. criteria of a risk policy stored in memory 22 and applied by apparatus 20 for the determining). For instance, the user may input such criteria on user interface 25 of apparatus 20. For instance, only content captured in a public and/or sensitive space may be considered to be associated with a potentially sensitive entity.

Content captured in a private space (e.g. the user's home) may for instance generally be determined to be not associated with a potentially sensitive entity. Also, content only to be published and/or shared with a restricted group of people (e.g. the user's social network contacts) may for instance generally be determined to be not associated with a potentially sensitive entity.

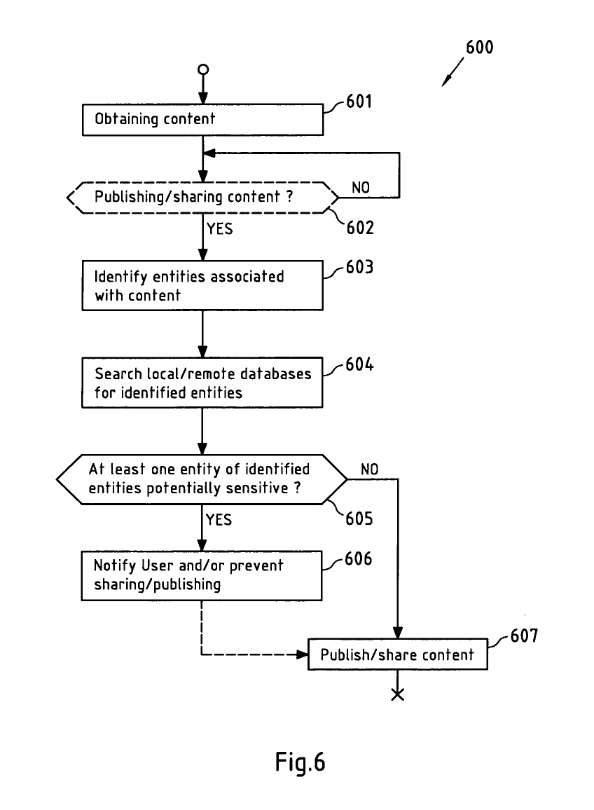

As described in detail below with respect to steps 603-605 of flowchart 600 of FIG. 6, the determining may comprise identifying entities associated with the content and checking whether or not at least one entity of the entities identified to be associated with the content is potentially sensitive.

Only if it is determined that the content is associated with at least one potentially sensitive entity, flowchart 500 proceeds to step 504. Otherwise, flowchart 500 directly proceeds to step 505.

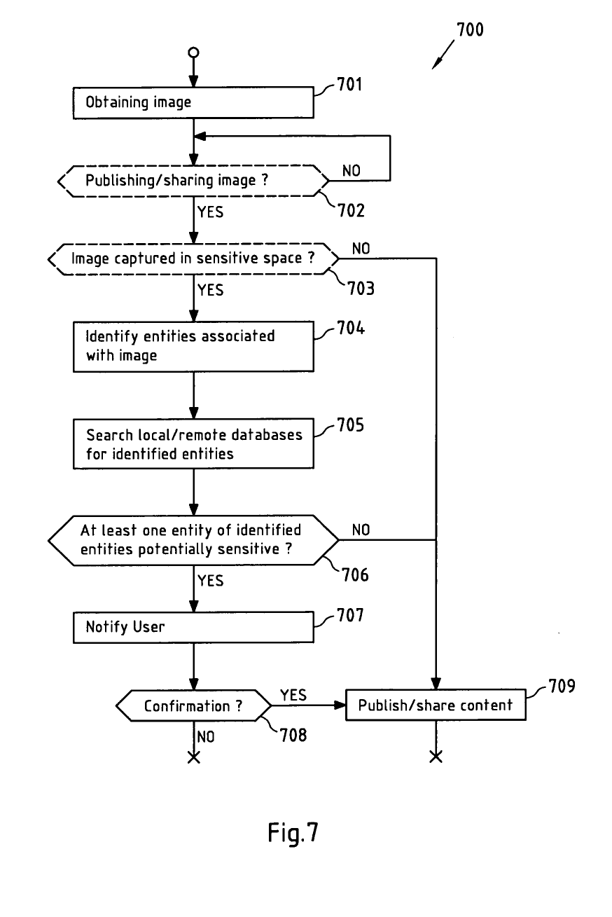

In step 504, the user of apparatus 20 is (non-modally) notified that the content is associated with at least one potentially sensitive entity and/or an at least unintentional sharing and/or publishing of the content is prevented. For instance, a corresponding notification may be presented to the user of apparatus 20 by user interface 25. In particular, the user may for instance be required to explicitly confirm sharing and/or publishing of the content on user interface 25 (e.g. see step 708 of flowchart 700 of FIG. 7). Otherwise, flowchart 500 may not proceed to step 505.

Alternatively or additionally, sharing and/or publishing of the content may for instance be prevented at all and/or the content may be put in quarantine.

In step 505, the content is published and/or shared. In particular, the content is published and/or shared as initiated in step 502. For instance, the content may be uploaded to a social network platform and/or a content-sharing platform, for instance transmitted from communication interface 24 of apparatus 20 to a server of the social network platform and/or the content-sharing platform (e.g. server 104 and/or 106 of FIG. 1a).

FIG. 6 is a flowchart 600 of another exemplary embodiment of a method according to the invention.

Flowchart 600 basically relates to sharing and/or publishing content.

In step 601, content is obtained at apparatus 20 of FIG. 2. Step 601 basically corresponds to step 501 of flowchart 500 of FIG. 5.

In step 602, it is determined whether or not the content is to be published and/or shared. Step 602 basically corresponds to step 502 of flowchart 500 of FIG. 5.

In step 603, one or more entities associated with the content are identified. As described above, an entity may be understood to be associated with the content, if the content at least potentially represents a characteristic trait of the entity. Accordingly, an entity may be identified to be associated with the content, if the content represents a characteristic trait of the entity and also if the content at least potentially represents a characteristic trait of the entity.

In the former case, the entity may for instance be (directly) identified by analyzing the content as described above. For instance, the analyzing may comprise facial recognition, voice recognition, character recognition and/or pattern recognition to identify one or more characteristic traits of entities represented by the content. An entity of which one or more characteristic traits are represented by the content may for instance be identified to be associated with the content.

In the latter case, the entity may for instance also be (indirectly) identified by analyzing information associated with the content as described above (e.g. meta information embedded in a data container in which also the content is stored). For instance, the information may comprise device identifier information received at communication interface 24 of apparatus 20 by scanning low range wireless communication systems when the content was captured and, thus, indicating that an entity associated with the received device identifier information was in proximity when the content was captured. An entity associated with the received device identifier information may for instance be identified to be associated with the content.

In step 604, locally and or remotely stored databases are searched for each of the entities identified to be associated with the content. Therein, the search criteria may for instance correspond to device identifier information comprised in the information and associated with the entities identified to be associated with the content and/or characteristic traits of the entities identified to be associated with the content represented by the content.

In case that a person is identified to be associated with the content, an address book/contact database of the user locally stored in memory 22 of apparatus 20 may for instance be searched for this person. Also, remotely stored databases may be searched for this person. For instance, a corresponding database request may be transmitted from communication interface 24 of apparatus 20 to a server (e.g. server 104 and/or 106 of FIG. 1 a) storing a social network database such that the user's social network contacts are searched for the person identified to be associated with the content.

In step 605, for each of the entities identified to be associated with the content, it is then checked whether or not the entity is potentially sensitive. For instance, a database entry found in step 604 may indicate whether or not the corresponding entity disagrees with sharing and/or publishing content representing the entity and/or at least a characteristic trait of the entity and/or under which conditions the entity agrees therewith.

As described above with respect to step 503 of flowchart 500 of FIG. 5, the user may set criteria defining whether or not an entity identified to be associated with the content is potentially sensitive (e.g. criteria of a risk policy stored in memory 22 and applied by apparatus 20 for the checking). For instance, a person identified to be associated with the content for which no database entry is found in step 604 may generally be determined to be potentially sensitive.

Only if it is determined that at least one of the entities identified to be associated with the content is potentially sensitive, flowchart 600 proceeds to step 606. Otherwise, flowchart 600 directly proceeds to step 607.

In step 606, user of apparatus 20 is (non-modally) notified that the content is associated with at least one potentially sensitive entity and/or an at least unintentional sharing and/or publishing of the content is prevented. Step 606 basically corresponds to step 504 of flowchart 500 of FIG. 5.

In step 607, the content is published and/or shared. Step 607 basically corresponds to step 505 of flowchart 500 of FIG. 5.

FIG. 7 is a flowchart 700 of another exemplary embodiment of a method according to the invention. Flowchart 700 basically relates to sharing and/or publishing an image on a social network platform. In the following, flowchart 700 is described for illustrative reasons only with respect to image 112 of FIG. 1b. However, flowchart 700 is to be understood to generally apply to sharing and/or publishing any image.

In step 701, image 112 is obtained at apparatus 20 of FIG. 2. Step 701 basically corresponds to step 501 of flowchart 500 of FIG. 5.

In step 702, it is determined whether or not image 112 is to be published and/or shared on the social network platform. Step 702 basically corresponds to step 502 of flowchart 500 of FIG. 5.

In optional step 703, it is checked whether or not image 112 was captured in a sensitive space. As described above with respect to optional step 402 of flowchart 400 of FIG. 4, the meta information embedded in the data container in which also image 112 is stored may comprise coordinates of the GPS system representing the position at which image 112 was captured. Based on this position information, it may be determined whether or not image 112 was captured in a sensitive space. For instance, a locally and/or remotely stored position database may be searched for information about the sensitivity of the position at which image 112 was captured. A sensitive space may for instance be a public space and/or a restricted area, whereas a private space (e.g. the user's home) may be non-sensitive.

Only if it is determined in optional step 703 that image 112 was captured in a sensitive space, flowchart 700 proceeds to step 704. Otherwise, flowchart 700 proceeds directly to step 709.

In step 704, one or more entities associated with image 112 are identified. Step 704 basically corresponds to step 603 of flowchart 600 of FIG. 6.

In particular, meta information associated with image 112 may be analyzed in step 704. As described above with respect to optional step 402 of flowchart 400 of FIG. 4, the meta information embedded in the data container in which also image 112 is stored may comprise Bluetooth device identifier information from each of the mobile devices 109, 110 and 111 carried by persons 101, 102 and 104, respectively. Accordingly, each of the Bluetooth device identifier information indicate that an entity associated with the device identified by the Bluetooth device identifier information was in proximity when image 112 was captured and, thus, may at least potentially be associated with the content. Based on analyzing the meta information, persons 101, 102 and 104 may be identified to be at least potentially associated with image 112. As apparent from image 112 of FIG. 1b, image 112 however represents persons 101 and 102 and car 103 (i.e. persons 101 and 102 and car 103 are actually associated with image 112).

To allow a more precise identification of entities actually associated with image 112, image 112 may (additionally or alternatively) be analyzed by pattern recognition and/or facial recognition in step 704. Based on face recognition, faces of persons 101 and 102 may be identified to be represented by image 112 and, thus, persons 101 and 102 may be identified to be associated with image 112. Furthermore, based on pattern recognition, car 103 and/or license plate 108 of car 103 may be identified to be represented by image 112 and, thus, car 103 may also be identified to be associated with image 112.

In step 705, locally and or remotely stored databases are searched for each of the entities identified to be associated with image 112. Step 705 basically corresponds to step 604 of flowchart 600 of FIG. 6. If persons 101, 102 and 104 are identified to be associated with image 112 based on Bluetooth device identifier information comprised in the meta information as described with respect to step 704, the databases may preferably be searched for the Bluetooth device identifier information. If persons 101 and 102 and car 103 are identified to be associated with image 112 based on face and/or pattern recognition as described with respect to step 704, the databases may preferably be searched for the recognized faces and/or patterns (e.g. license plate 108).

Since persons 101 and 102 are connected with the user of apparatus 20 on the social network platform, corresponding database entries may be found on the social network platform. However, for person 104 and/or car 103 no corresponding database entry may be found.

In step 706, for each of the entities identified to be associated with image 112, it is then checked whether or not the entity is potentially sensitive. Step 706 basically corresponds to step 605 of flowchart 600 of FIG. 6.

For instance, the user of apparatus 20 may have been set that persons known to the user are to be determined to be not sensitive. Furthermore, the user may have been set that persons unknown to the user and cars having visible license plates are generally to be determined to be to potentially sensitive. If database entries corresponding to persons 101 and 102 are found in step 705 as described above, persons 101 and 102 may accordingly be determined to be not sensitive. If person 104 and/or car 103 are identified to be associated with image 112 in step 704 and no database entries corresponding to person 104 and/or car 103 entries are found in step 705 as described above, person 104 and/or car 103 may accordingly be determined to be potentially sensitive.

Only if it is determined that at least one of the entities identified to be associated with image 112 is potentially sensitive, flowchart 700 proceeds to step 707. Otherwise, flowchart 700 directly proceeds to step 709.

In step 707, the user of apparatus 20 is notified that at least one entity associated with image 112 is potentially sensitive. For instance, a corresponding warning may be presented on a display comprised of user interface 25 of apparatus 20. For instance, image 112 may be displayed on user interface 25 and one or more characteristic traits of the at least one potentially sensitive entity recognized in step 704 may preferably be highlighted. The user may request to blur the highlighted portion of image 112.

For instance, if car 103 is determined to be potentially sensitive, image 112 may be displayed on user interface 25 and license plate 108 of car 103 recognized in step 704 may be highlighted. If person 104 is determined to be potentially sensitive, for instance the name of person 104 as listed in the phonebook (e.g. a address book/contact database stored in memory 22) or in a social network (e.g. a social network database stored on server 104 and/or 106) or the corresponding Bluetooth device identifier information may be output by user interface 25.

In step 708, the user of apparatus 20 is required to explicitly confirm sharing and/or publishing of the content on user interface 25. For instance, a mandatory confirmation box may be presented on a display comprised of user interface 24 requiring the user to explicitly confirm to share and/or publish the content. Only if the user checks the mandatory confirmation box, the content may for instance be shared and/or published.

Only if the user confirms to share and/or publish the content in step 708, flowchart 700 proceeds to step 709. Otherwise, flowchart 700 is terminated.

In step 709, the content is published and/or shared on the social network platform. Step 709 basically corresponds to step 505 of flowchart 500 of FIG. 5.

In the following, an exemplary embodiment according to the invention is described illustrating some advantages and features of the invention.

People nowadays use their mobile phones/devices (e.g. content capturing device 100 of FIG. 1a) often not only to capture visual content (e.g. images, pictures), but also to immediately upload the content to a given server (e.g. server 104 of FIG. 1a) and share it with their friends, family, and social network. Compared with traditional digital cameras, this is facilitated by the fact that mobile devices have easy communication means (e.g. WLAN, GSM, UMTS, etc.). Pushing it one step further, taking advantage of the knowledge that the mobile device has about the user, the user can semi-automatically share it with the people in the vicinity who happen to be in the picture.

For instance, there is on-going research to use face recognition and person-to-device-binding techniques to add metadata to media indicating who is present in a photo or who was nearby when a photo was taken.

Publishing an image representing an unknown person and/or one or more characteristic traits of the unknown person may raise privacy and liability issues. Warning the user about this risk is therefore a valuable feature.

For instance, when a user of apparatus 20 of FIG. 2 (e.g. corresponding to content capturing device 100 of FIG. 1a) requests to share and/or publish an image (e.g. to upload the image), a computer program running on apparatus 20 may cause apparatus 20 to realize identifying people in the image using image processing (e.g. facial recognition) and proximity information stored within the image when it was taken (e.g. see step 704 of flowchart 700 of FIG. 7). The computer program may for instance be a computer program application (e.g. a so-called app).

The computer program may then cause apparatus 20 to realize checking whether everyone in the image is known to the user, for instance by checking contact information locally stored in memory 22 and/or 23 of apparatus 20, social network information etc. (e.g. see step 705-706 of flowchart 700 of FIG. 7). If there are people in the image that are unknown to the user, the user is warned of publishing images of people without their consent (e.g. see step 707 of flowchart 700 of FIG. 7). Furthermore, unknown people may optionally be pointed out in the image and it may be proposed to the user to automatically blur the privacy sensitive portions of the image (e.g. see step 707 of flowchart 700 of FIG. 7).

Many content capturing devices (e.g. mobile phones, digital cameras) nowadays store contextual information (e.g. meta information) within the content, typically GPS coordinates, user tags etc. Similarly, according to the invention, proximity information such as Bluetooth scans, location information (GPS, WLAN, etc.) are stored in order to be able to identify the location as well as the persons/people around the user (e.g. see optional step 402 of flowchart 400 of FIG. 4). Location information can be later used to check whether the user was in a public space or at home when capturing the content. Vicinity information (e.g. proximity information) such as Bluetooth scans can be later used to help identifying the persons represented by the image.

Upon starting an image upload, the computer program running on apparatus 20 (e.g. a camera application, a web application, a social network application, etc.) may cause apparatus 20 to start identifying whether there are persons present in the image using image face recognition/facial recognition (e.g. see step 704 of flowchart 700 of FIG. 7). If there are persons present, it is then checked whether they are familiar to the user who is uploading the image (e.g. see step 705 of flowchart 700 of FIG. 7). Familiarity information can for instance be inferred by using the Bluetooth identifiers stored in the image, and the faces located in the image, for instance by searching Bluetooth identifiers stored in the image and faces of people represented by the image in a contact repository (e.g. locally stored in memory 22 and/or 23 of apparatus 20) and/or on the user's social network server (remotely), if contact photos and Bluetooth identifier are stored therein.

If the previous comparison results in identifying unfamiliar people (e.g. strangers) in the image to be uploaded, the user is warned of the risk of uploading and/or sharing and/or publishing images representing persons without their consent (e.g. see steps 706-708 of flowchart 700 of FIG. 7). Together with the warning, the strangers may be pointed out in the image using some overlaying masks, text, drawings etc. and it may be proposed to blur them (e.g. see step 707 of flowchart 700 of FIG. 7).

Therein, it may be configurable by the user, when exactly to warn the user. In all cases, the warning is triggered by detecting the presence of sensitive persons/people in the content (e.g. image/picture/photo, video and/or audio recording, Bluetooth identifiers or MAC/IP addresses that are linkable to the sensitive entity) being shared. But the set of sensitive person may change from user to user. Non-limiting examples of sensitive persons/people are strangers and/or a specific set of persons/people (e.g. persons/people who do not want to share images of their children). Also, the notion of sensitive persons/people can be broadened to sensitive objects and/or sensitive entities as described above. For example it may be illegal or risky to share photos of important buildings, bridges, car license plates etc.

The warning may depend on the where the content is being sent to, for instance on the addressee to which the content is being sent to. For instance, a user may be willing to share content representing sensitive entities in a private album, but not to in a public album.

When the user uploads a large number of content (e.g. an album) or when content is automatically uploaded, the warning operation may be explicit such as a modal dialog (e.g. pop-up asking “this photo has strangers; do you really want to upload (yes/no)”) or, preferably, a non-modal notification (e.g. information message saying “photos with strangers have been quarantined in the quarantine album; visit this album to review the quarantined photos”).

A naive solution would be to issue an automatic warning like “Beware of publishing pictures of foreign people” whenever a user uploads/shares a picture, regardless of the location, context, or who is in the picture. The fact that it is always automatically issued makes it an annoyance, easily overlooked by the user. Restricting the warnings to pictures that happen to include foreign people obviously has better impact on the attention and the user experience.

As used in this application, the term ‘circuitry’ refers to all of the following:

(a) hardware-only circuit implementations (such as implementations in only analog and/or digital circuitry) and
(b) combinations of circuits and software (and/or firmware), such as (as applicable):
(i) to a combination of processor(s) or
(ii) to portions of processor(s)/software (including digital signal processor(s)), software, and memory(ies) that work together to cause an apparatus, such as a mobile phone or a positioning device, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a positioning device.

As used in this application, the wording “X comprises A and B” (with X, A and B being representative of all kinds of words in the description) is meant to express that X has at least A and B, but can have further elements. Furthermore, the wording “X based on Y” (with X and Y being representative of all kinds of words in the description) is meant to express that X is influenced at least by Y, but may be influenced by further circumstances. Furthermore, the undefined article “a” is—unless otherwise stated—not understood to mean “only one”.

The invention has been described above by means of embodiments, which shall be understood to be non-limiting examples. In particular, it should be noted that there are alternative ways and variations which are obvious to a skilled person in the art and can be implemented without deviating from the scope and spirit of the appended claims. It should also be understood that the sequence of method steps in the flowcharts presented above is not mandatory, also alternative sequences may be possible.

1-28. (canceled)

29. Method performed by an apparatus, at least comprising:
obtaining content at a device,
determining whether or not said content is associated with at least one potentially sensitive entity, and
in case that it is determined that said content is associated with at least one potentially sensitive entity, non-modally notifying a user of said device that said content is associated with at least one potentially sensitive entity and/or preventing an at least unintentional sharing and/or publishing of said content by a user of said device.

30. The method of the claim 29, wherein said determining comprises:
identifying one or more entities associated with said content, and
checking whether or not at least one entity of said entities identified to be associated with said content is potentially sensitive.

31. The method of the claim 29, wherein said determining is at least partially based on analyzing information associated with said content.

32. The method of the claim 29, wherein said determining is at least partially based on analyzing said content.

33. The method of claim 32, wherein said analyzing comprises image recognition and/or audio recognition such as pattern recognition, voice recognition and/or facial recognition.

34. An apparatus, at least comprising at least one processor, and at least one memory including computer program code, said at least one memory and said computer program code configured to, with said at least one processor, cause said apparatus at least to perform:
obtain content at a device,
determine whether or not said content is associated with at least one potentially sensitive entity, and
in case that it is determined that said content is associated with at least one potentially sensitive entity, non-modally notify a user of said device that said content is associated with at least one potentially sensitive entity and/or prevent an at least unintentional sharing and/or publishing of said content by a user of said device.

35. An apparatus of claim 34, wherein said content represents a characteristic trait of said least one potentially sensitive entity.

36. An apparatus of claim 34, wherein said at least one potentially sensitive entity is associated with said content and is at least considered to be not associated with said user.

37. The apparatus of claim 34, wherein the at least one memory including the computer program code is further configured to, with the at least one processor, cause the apparatus to perform:
identify one or more entities associated with said content, and
check whether or not at least one entity of said entities identified to be associated with said content is potentially sensitive.

38. The apparatus of claim 34, wherein the at least one memory including the computer program code is further configured to, with the at least one processor, cause the apparatus to determine at least partially based on analyzing information associated with said content.

39. The apparatus of claim 28, wherein said information comprises position information and/or proximity information.

40. The apparatus of claim 39, wherein said proximity information comprises device identifier information identifying one or more devices communicating in a wireless communication system, said device identifier information receivable at a position at which said content was captured when said content was captured.

41. The apparatus of claim 40, wherein it is determined that said content is associated with at least one potentially sensitive entity, if at least one entity associated with at least one device of said devices identified by said device identifier information is considered to be not associated with said user.

42. The apparatus of claim 40, wherein the at least one memory including the computer program code is further configured to, with the at least one processor, cause the apparatus to search said device identifier information in contact information stored in a local database on said device and/or in a remote database on a network element.

43. The apparatus of claim 34, wherein the at least one memory including the computer program code is further configured to, with the at least one processor, cause the apparatus to determine at least partially based on analyzing said content.

44. The apparatus of claim 43, wherein the at least one memory including the computer program code is further configured to, with the at least one processor, cause the apparatus to recognize image and/or audio such as pattern recognition, voice recognition and/or facial recognition.

45. The apparatus of claim 44, wherein it is determined that said content is associated with at least one potentially sensitive entity, if at least one entity recognized by said image recognition is at least considered to be not associated with said user.

46. The apparatus of claim 45, wherein the at least one memory including the computer program code is further configured to, with the at least one processor, cause the apparatus to search a face of said person in portrait images stored in an address book/contact database of said user and/or in portrait images of social network contacts of said user.

47. The apparatus of claim 46, wherein the at least one memory including the computer program code is further configured to, with the at least one processor, cause the apparatus to determine at least partially based on information about said user of said device and/or on information about said at least one potentially sensitive entity.

48. The apparatus of claim 47, wherein said information about said user of said device and/or about said at least one potentially sensitive entity is contact information, privacy information and/or social network information.

49. The apparatus of claim 47, wherein said information is stored on said device and/or on a network element.

50. The apparatus of claim 34, wherein the at least one memory including the computer program code is further configured to, with the at least one processor, cause the apparatus to be trigged by an action directed to sharing and/or publishing said content.

51. The apparatus of claim 34, wherein the at least one memory including the computer program code is further configured to, with the at least one processor, cause the apparatus to blur and/or distort at least a characteristic trait of said at least one potentially sensitive entity represented by said content.

52. The apparatus of claim 34, wherein the at least one memory including the computer program code is further configured to, with the at least one processor, cause the apparatus to prevent an at least unintentional sharing and/or publishing to perform at least one of:
require said user to explicitly confirm sharing and/or publishing said content,
put said content in quarantine, and
prevent sharing and/or publishing of said content at all.
